(19) United States
(12) Patent Application Publication
(10) Pub. No.: US 2018/0093265 A1
(43) Pub. Date: Apr. 5, 2018

(54) Electropermanent magnet activated microfluidic droplet size modulation

(71) Applicants: The Board of Trustees of the Leland Stanford Junior University, Palo Alto, CA (US); Cairo University, Giza City (EG)

(72) Inventors: Jose I. Padovani Blanco, Palo Alto, CA (US); Ali Mohamed Ibrahim, Helwan (EG); Yasser Hussein Anis, Sheikh Zayed (EG); Stefanie S. Jeffrey, Stanford, CA (US); Roger T. Howe, Los Gatos, CA (US)

(21) Appl. No.: 15/281,535

(22) Filed: Sep. 30, 2016

(51) Int. Cl. B01L 3/00; F15D 1/02

(52) U.S. Cl. CPC B01L 3/50273; F15D 1/02; B01L 2300/06; B01L 2200/06; B01L 2400/043

(57) ABSTRACT

An active microfluidic droplet generation device includes a droplet generation junction joining at least one continuous phase channel for carrying a ferrofluid, and a dispersed phase channel for carrying a dispersed phase (e.g., aqueous) flow. A miniature electropermanent magnet (EPM) upstream from the junction generates a magnetic field to modulate a flow rate of a ferrofluid in the continuous phase channel so that dispersed phase droplets are generated with volumes actively controlled on-demand and under continuous flow.

### FIELD OF THE INVENTION

The invention relates generally to microfluidics. More specifically, it relates to active microfluidic water droplet generation devices and techniques.

### BACKGROUND OF THE INVENTION

Droplet generation is a key stage in all droplet microfluidic systems. The most common methods of continuous flow droplet generation are T-junction and flow focusing. The latter is preferred in most systems for its faster generation speed and overall smaller droplet sizes. Flow focusing droplet generation, as shown in FIG. 1A, uses the intersection of two oil channels 100, 102 and one aqueous channel 104, to generate monodisperse aqueous droplets 106. Tuning the flow rate ratio between the oil and aqueous channels leads to droplet size modulation. As shown in FIG. 1B, for a mineral oil and water system, higher ratios lead to smaller droplets. This size modulation method, although simple and widely used, has a significant disadvantage: response speed. Using syringe pumps, flow rate stabilization following a change is on the order of seconds or even minutes. During the stabilization period, the generated droplet sizes change slowly as well.

Active methods are required for fast droplet size changes. The most common control method is electrical. Thermal, mechanical and magnetic control methods have also been demonstrated. Of these methods, magnetic control has seen the least development and impact. There are two main reasons for such limited impact. First, demonstrated methods use water-based ferrofluids as the discrete phase and mineral oil or silicone oil as the continuous phase. Ferrofluid droplets have limited use since the contents of the droplet are exposed to iron oxide nanoparticles. The presence of these nanoparticles can be detrimental for applications in cell biology or chemical reactions. The second limiting factor is the magnetic source. Demonstrated methods have used either permanent magnets or electromagnets to generate the magnetic field. Permanent magnets, although magnetically strong, do not provide ON/OFF switching capability. Obtaining multiple droplet sizes with a permanent magnet requires physically moving the magnet with respect of the generation region: a slow process with limited precision. Electromagnet-driven methods do provide ON/OFF switching capability, albeit at slower rates than electrical control. Also, conventional electromagnets are large, making them unsuited for complex and dense microfluidic architectures with multiple independent magnetic actuators.

### SUMMARY OF THE INVENTION

The above problems with existing methods for active droplet generation are solved by the present invention.

In one aspect, the present invention uses oil-based ferrofluids as the continuous phase. A dispersed, or discrete, phase is preferably an aqueous fluid. Mineral oil-based ferrofluids, in contrast with commercially available oil-based ferrofluids, are compatible with PDMS, thus enabling a more widespread use of ferrofluids for microfluidics research and development. The present invention also uses miniature electropermanent magnets (EPMs) as the magnetic field source. EPMs provide ON/OFF capability while also delivering magnetic field strengths comparable to permanent magnets, at length scales suitable for multi-EPM microfluidic systems.

The EPM is used for active droplet generation by modulating the continuous phase (ferrofluid) flow rate. EPM poles are placed in close proximity to the input ferrofluid lines, upstream from the droplet generation junction. Once the EPM is activated, with a short high-current pulse, the local viscosity of the ferrofluid increases and leads to a decrease in the flow rate. Since the aqueous flow rate remains constant, the oil-to-water flow rate ratio decreases thus increasing generated droplet size.

In one aspect, the invention provides a method for active microfluidic droplet generation. According to the method, a miniature electropermanent magnet (EPM) is positioned such that a magnetic field of the EPM overlaps with microfluidic channels connected to a droplet generation junction upstream from the droplet generation junction. The magnetic field of the EPM is controlled to modulate a continuous phase ferrofluid flow rate in the microfluidic channels while a dispersed phase flows through a dispersed phase channel connected to the droplet generation junction. As a result, dispersed phase droplets are generated with volumes actively controlled on-demand and under continuous flow.

Preferably, the EMP is aligned such that the magnetic field is substantially orthogonal to the microfluidic channels containing the ferrofluid.

The magnetic field of the EPM is preferably controlled to induce a change in viscosity of the ferrofluid through the magnetoviscous effect. The magnetic field of the EPM is preferably activated and deactivated by generating current pulses through a coil of the EPM. By controlling a magnitude of current pulses in coils of the EPM, a magnitude of the magnetic field is controlled. The magnitude of current pulses in the coils of the EPM may be controlled to produce a maximum magnetic field strength of at least 200 mT at a pole of the EPM. The generated current pulses through the coil of the EPM may have pulse widths less than 100 microseconds. Instead of switching the EPM, the EPM can be maintained activated, without power consumption, with the result that the volume of the generated dispersed phase droplets is constant.

In another aspect, an active microfluidic droplet generation device is provided. The device includes a droplet generation junction having at least one continuous phase channel adapted for carrying a flow of ferrofluid, and a dispersed phase channel adapted for carrying a dispersed phase flow. The device also includes a miniature electropermanent magnet (EPM) positioned upstream from the droplet generation junction and adapted to generate a magnetic field to modulate a flow rate of a ferrofluid in the continuous phase channel. Preferably, the EPM is aligned such that the magnetic field is substantially orthogonal to the continuous phase channel. The EPM is preferably positioned within 200 microns of the continuous phase channel.

The droplet generation junction may be, for example, a T-junction having just one continuous phase channel, or a flow-focusing junction having two continuous phase channels. The continuous phase channel and the dispersed phase channel may have side and top walls formed of polydimethylsiloxane (PDMS) and bottom walls formed of glass.

In preferred embodiments, the ferrofluid is composed of superparamagnetic nanoparticles suspended in oil or water-based carrier liquid. The dispersed phase flow may be an aqueous phase flow, or a buffer or cell growth media.

Embodiments of the present invention have many advantages over existing techniques. Microfluidic devices that use electrical energy to control the size of droplets have electrodes that apply voltage to a conducting fluid in order to manipulate the droplet generation process. Electrostatic devices have the following drawbacks: Electrodes are always in direct contact with fluids, which makes them vulnerable to fouling, which affects the system reliability. In contrast, the present invention provides contactless control of droplet size. Second, the droplets are charged, which makes them unsuitable for encapsulating sensitive chemical or biological samples. In contrast, droplets in the present invention are not charged. Third, the dispersed phase fluid is limited to conductive fluids only, whereas the present invention can work with any kind of dispersed fluid phase.

Microfluidic devices that use thermal effects to control droplet size use resistive heaters or laser beams to change the fluid properties responsible for droplet formation, which are mainly viscosity and interfacial tension. The major drawback of this control method is that the heat affects the temperature of the whole device, which makes it difficult to integrate this method of control with other independent processes within the same device. In contrast, the present invention has a localized effect on the fluid used and does not change its temperature.

Existing microfluidic devices that control droplet size magnetically suffer from two main drawbacks: 1) The discrete phase fluid used is a water-based ferrofluid. Ferrofluid droplets aren't suitable for sensitive chemical and biological applications due to the existence of iron oxide nanoparticles inside these droplets. In contrast, the present invention uses water for the discrete phase and ferrofluid as the continuous phase, thus eliminating this problem. 2) The type of magnet used in existing devices is either a permanent magnet or an electromagnet. Permanent magnets, fixed in position, cannot provide different droplet sizes, and do not provide ON/OFF switching capability. Changing permanent magnet position to obtain different droplet sizes is a slow process with limited precision. Electromagnets provide ON/OFF switching capability but at relatively slow rates. In contrast, the present invention uses a miniature EPM that is much smaller than conventional electromagnets, provides fast ON/OFF switching capability, and can deliver magnetic field strengths comparable to permanent magnets.

Existing microfluidic devices that control droplet size using hydraulic or pneumatic actuators to physically deform the interface between two liquids have various drawbacks: The response speed of these actuators is relatively slow (in contrast, EPM switching time is less than 100 μs). Fabrication of these devices is complicated due to its moving parts. In contrast, the present invention does not require any moving parts. The continuous physical deformation of microfluidic channels, which are usually made of elastic materials like PDMS, may introduce cracks or permanent deformations that affects the performance of the system. In contrast, the EPM used in the present invention does not subject the microfluidic channels to any kind of deformations.

Existing microfluidic devices that control droplet size using piezoelectric actuators to physically deform the interface between two liquids have various drawbacks: The continuous physical deformations/vibrations done to the microfluidic device by the piezoelectric actuator may affect the device performance. In contrast, the EPM used in the present invention does not cause any kind of deformations/vibrations. The piezoelectric substrate required for the fabrication of the actuator is relatively expensive. In contrast, the EPM and substrate used in the present invention are inexpensive.

### BRIEF DESCRIPTION OF THE DRAWINGS

FIG. 1A is a cross-sectional top view of a conventional flow-focusing junction with two oil-based ferrofluid channels pinching off the water channel to create water droplets.

FIG. 1B is a graph of droplet diameter as a function of oil-to-water flow rate ratio (Qₒ/Q_{w}), showing that droplet size decreases for larger ratios.

FIG. 2A is a schematic top view of input microfluidic channels and flow-focusing junction, where the positions of EPM poles are shown as dotted lines, according to an embodiment of the invention.

FIG. 2B is a perspective view of an EPM, microfluidic channels and junction, showing pole-channel alignment and separation of EMP from the channels by the thickness of the glass coverslip, according to an embodiment of the invention.

FIGS. 3A-F are perspective views of an EPM, microfluidic channels and junction, showing steps of active droplet size control process with EPM actuation, where the widths of the arrows reflect the flow rate of the ferrofluid, according to an embodiment of the invention.

FIG. 4A is a graph of magnetic field modulation for different actuation currents, according to an embodiment of the invention.

FIG. 4B is a graph of magnetic field modulation for different pulse lengths, according to an embodiment of the invention.

FIG. 5 is a graph of relative viscosity increase in the ferrofluid for applied magnetic field, according to an embodiment of the invention.

FIGS. 6A-B are diagrams of generated droplets in microfluidic channels, illustrating active droplet size control using mineral oil based ferrofluid and EPM actuation, where Q_{w} represents the water flow rate and Qₒ the oil flow rate, according to an embodiment of the invention.

FIG. 7 is a graph of droplet size tuning for multiple flow rates and actuation currents, where the water flow rate was fixed at 0.1 μl/min, according to an embodiment of the invention.

FIG. 8 is a graph of droplet diameter change at multiple flow rates and actuation currents with the water flow rate fixed at 0.1 μl/min, illustrating that shear-thinning effect becomes dominant at higher flow rates, according to an embodiment of the invention.

FIG. 9 is a diagram of generated droplets in microfluidic channels, illustrating on-demand droplet size increase by EPM ON time tuning, where single large droplet generation is demonstrated using 25-50 ms ON time, according to an embodiment of the invention.

### DETAILED DESCRIPTION

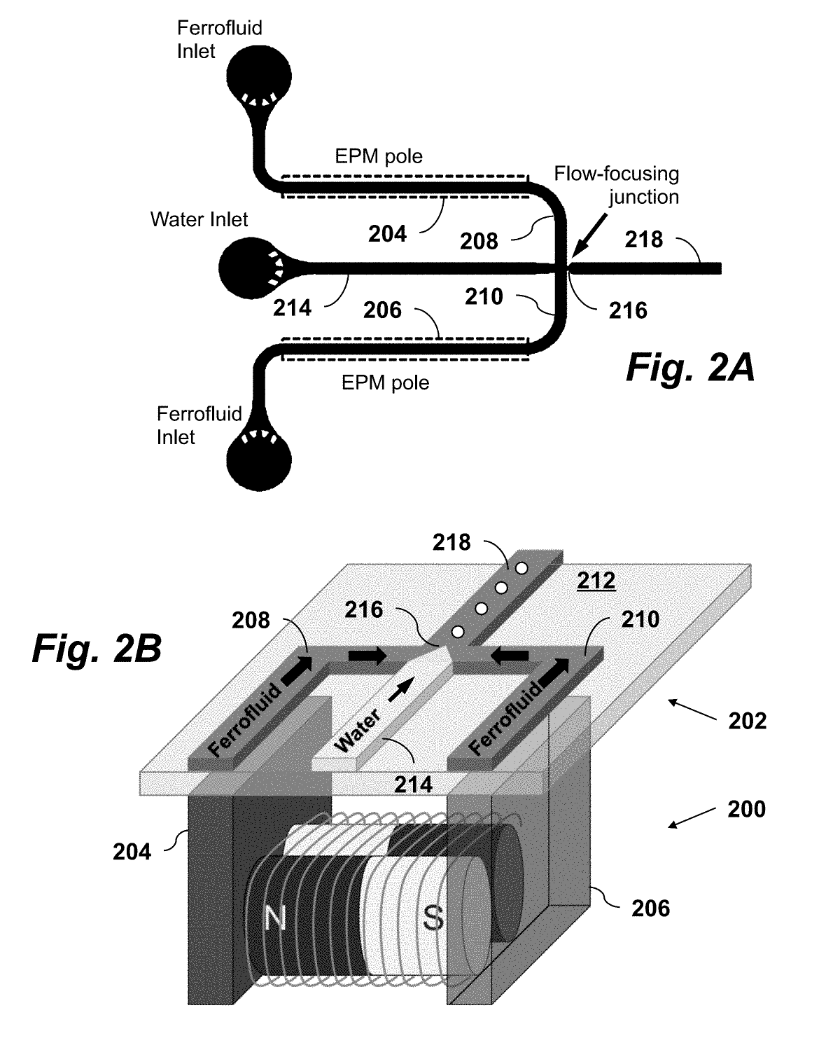

According to an embodiment of the present invention, active droplet size control using an EPM 200 is performed in a PDMS microfluidic chip 202 with flow-focusing configuration as shown in FIGS. 2A-B. The EPM's ferromagnetic poles 204, 206 are aligned underneath the two input ferrofluid lines 208, 210, separated from the channel by the glass coverslip 212 with thickness 0.13-0.16 mm. The ferrofluid channels join a water channel 214 at a junction 216, which is also joined to an output channel 218. The input ferrofluid microchannels width preferably should not exceed the EPM poles width to maximize actuation. This embodiment uses 200 μm channels with 350 μm EPM poles due to PDMS fabrication constrains. For 50 μm tall channels, the maximum channel width should not exceed four times the height to prevent channel collapse. The length of the input ferrofluid channel straight section is designed to match the length of the EPM poles, 3.6 mm, again to maximize actuation.

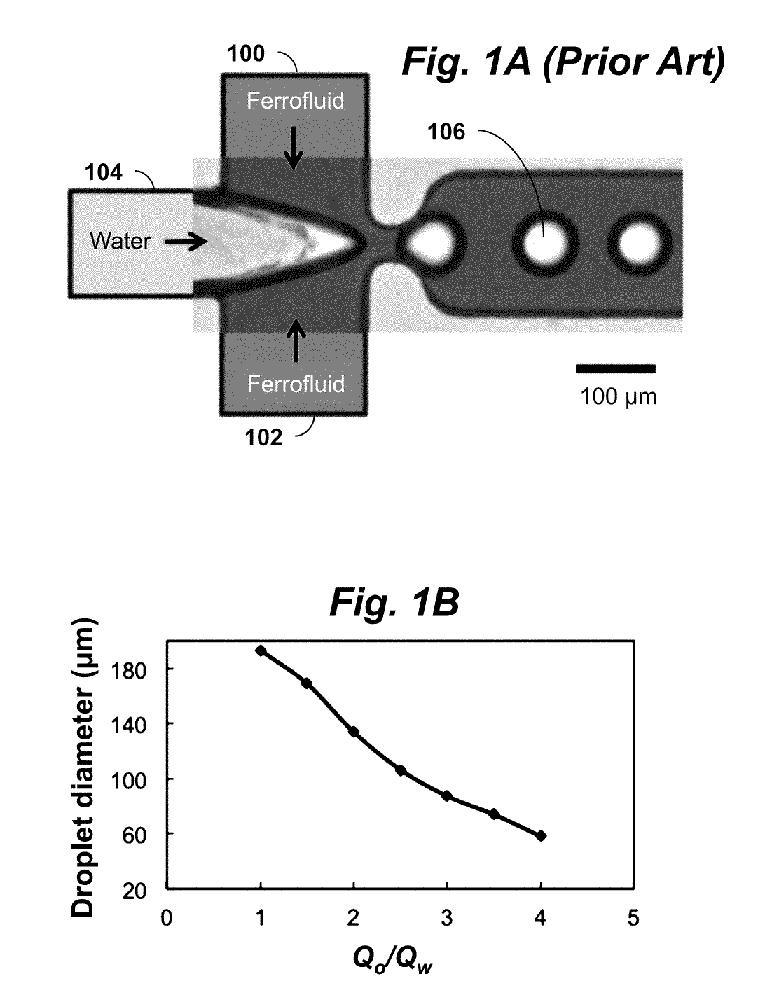

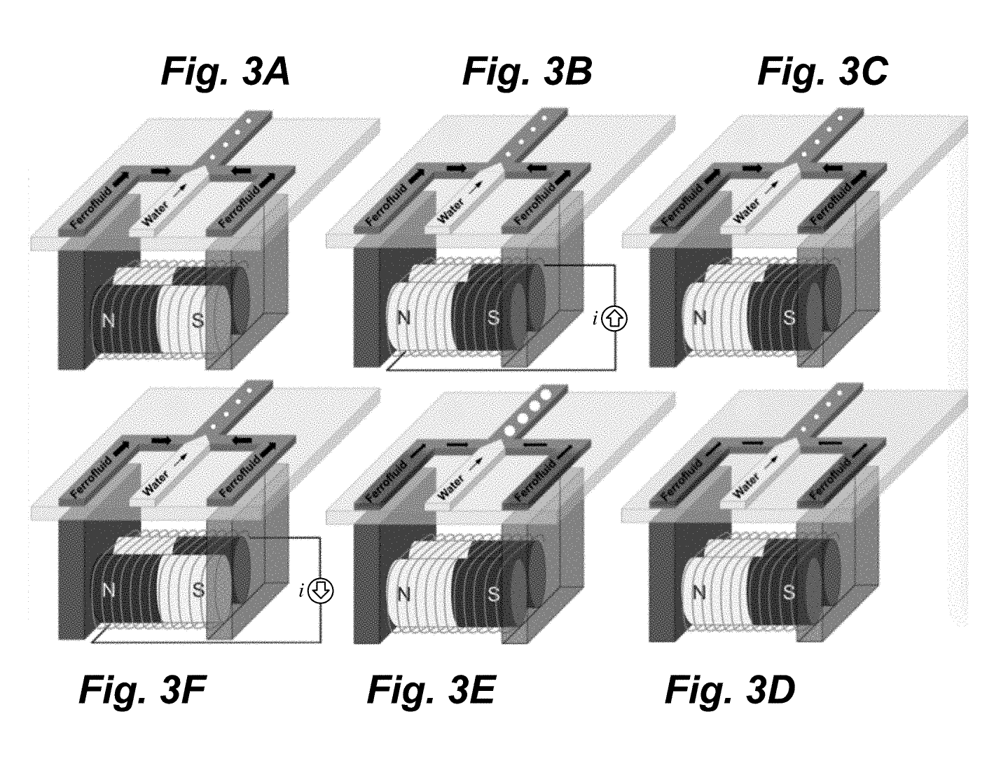

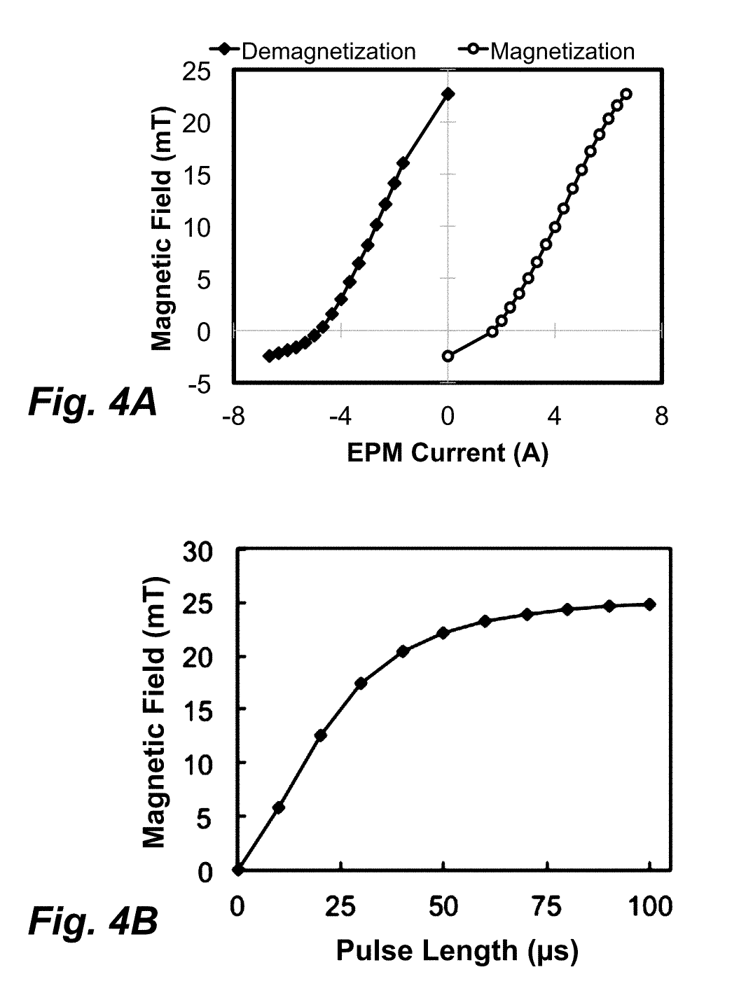

A process of active droplet size control using EPM according to an embodiment of the invention is shown in FIGS. 3A-F. The process starts with stabilized ferrofluid and water flow rates in ferrofluid and water inlet channels, generating droplets of uniform size in the output channel, and the EPM OFF (FIG. 3A). Using a positive current pulse, the magnetizations of the magnets are aligned and the EPM is turned ON (FIG. 3B). The magnetic field at the edge of the EPM poles induces a localized increase in the ferrofluid's viscosity by a process called the magnetoviscous effect (MVE) (FIG. 3C). MVE is described in more detail below. The increased viscosity increases the fluidic resistance of the input channels decreasing the flow rate (FIG. 3D). As seen in FIG. 1B, a decrease in the oil flow rate decreases the oil-to-water flow rate ratio leading to generation of larger droplets (FIG. 3E). Larger droplet size generation will be sustained while the EPM is ON but no power will be drawn since the EPM only draws power for switching but consumes zero power afterwards. Using a negative current pulse, the magnetizations of the magnets are reversed and the EPM is turned OFF (FIG. 3F), thus restoring to the original flow settings from FIG. 3A. This process can be repeated at high rates, and it is only limited by the switching time of the EPM (which is less than 100 μs). Also, by using different actuation currents or pulse lengths, the EPM can be activated to multiple magnetization levels, each delivering droplets of different sizes. For example, FIG. 4A shows magnetic field modulation for different actuation currents, and FIG. 4B shows magnetic field modulation for different pulse lengths.

A key feature of the present invention is the exploitation of the magnetoviscous effect to induce a localized increase in the ferrofluid's viscosity. The magnetoviscous effect, or MVE, is the process in which the magnetic moments of the ferrofluid's nanoparticles try to align with the applied magnetic field, generating a magnetic torque that will hinder the free rotation of the particles, macroscopically increasing viscosity. The viscosity increase can be quantified by a rotational viscosity term

$${η}_{r} = \frac{3}{2} {η}_{s} φ \frac{α - tanh α}{α + tanh α} 〈 {sin}^{2} β 〉 \qquad Eq . 1$$

and the total viscosity is given by

η=η₀+ηᵣ. Eq. 2

In Eq. 1 and 2 above, ηₛ is the carrier oil viscosity, φ is the volume fraction of magnetic solids in the ferrofluid, β is angle between the magnetic field and flow vorticity, and α is the Langevin parameter given by

$$α = \frac{π}{6} \frac{{μ}_{0} {M}_{d} {Hd}_{p}^{3}}{kT} , \qquad Eq . 3$$

where μ₀ is the permeability of free space, H is the magnitude of the magnetic field, dₚ is the diameter of the magnetic core of the nanoparticles (˜6 nm), k is the Boltzmann constant and T is the temperature.

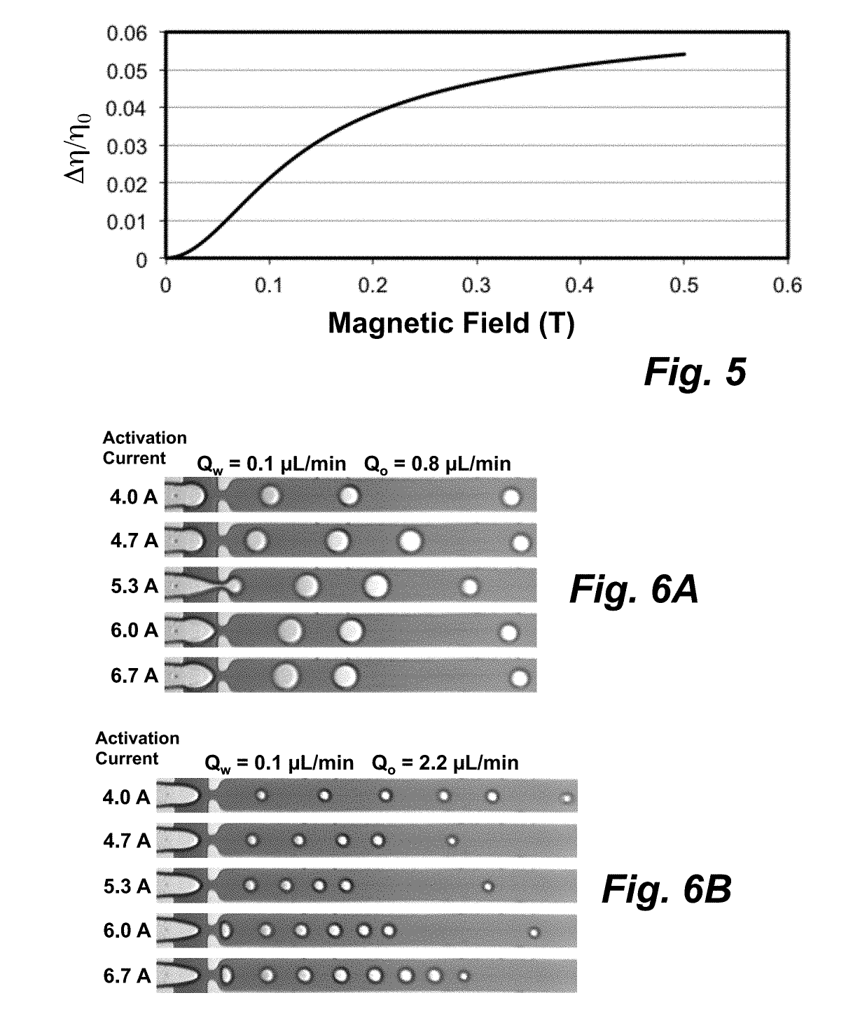

From Eq. 1-3, there are several important concepts to consider. First, the applied magnetic field should be orthogonal (β=90°) to the flow vorticity for maximum viscosity change. Collinear magnetic field (β=0°) will result in zero change in viscosity. In microfluidic channels, the vorticity is defined as orthogonal, but in plane, to the flow direction. The EPMs generate a magnetic field that crosses the channel in the out-of-plane direction, orthogonal to the flow vorticity. Second, the choice of ferrofluid locks the rest of the variables except H. This implies the active viscosity control depends entirely on the magnetic field strength. FIG. 5 shows the change in viscosity for magnetic fields in the range of operation of the EPMs.

The EPM design used in this embodiment can generate a magnetic field of 0.3 T at the edge of the poles. With the microfluidic channels located approximately 130 μm from the poles (glass thickness), the magnetic field is roughly 0.2 T, corresponding to a 3-4% increase in viscosity. Stronger EPMs or thinner substrates can lead to even higher viscosities, but due to the saturation of the ferrofluid magnetization, the viscosity will saturate too at approximately 6% increase. Ferrofluids with higher saturation magnetization could be used for larger viscosity changes.

The change in viscosity is related to a change in flow rate through the Hagen-Poiseuille law

$$Q = \frac{Δ p}{{R}_{hyd}} , \qquad Eq . 4$$

where Δp represents the pressure differential and R_{hyd} is the fluidic resistance across the channel. For a rectangular channel, R_{hyd} can be approximated by

$${R}_{hyd} = \frac{12 η L}{{h}^{3} w ( 1 - 0.63 \frac{h}{w} )} , \qquad Eq . 5$$

where h, w, and L represent the height, width, and length of the channel, respectively. From Eq. 4-5, an increase in viscosity η increases the fluidic resistance and decreases the flow rate, assuming constant Δp.

Another phenomenon that will affect the viscosity change, and resulting droplet size, is shear thinning. Ferrofluids display non-Newtonian behavior when nanoparticles form chains under applied magnetic field. Chain formation is accounted for in more complex magnetoviscous effect models, but in simple terms, longer chains lead to higher viscosity. At higher shear rates (flow rates), these chains are broken, or not allowed to form, thus reducing the magnetoviscous effect.

In experimental tests of the embodiment described above, active droplet size control was demonstrated using EPM actuation. Mineral oil based ferrofluid with 4.5% v/v solid magnetic content and 5% w/w Span80 surfactant was used for the continuous phase and water for the discrete phase. FIGS. 6A-B show increased droplet size generation for multiple actuation currents and two different flow rate settings. Actuation currents from 4 to 6.7 A were used. The leading droplet (far right) on each image represents the last droplet generated without EPM actuation and the rest of the droplets (all larger) generated after EPM activation. Besides droplet size, EPM actuation also affects inter-droplet spacing. FIG. 6A shows images of the output channel containing droplets generated under low flow rate, where droplets increase from 135 μm to 185 μm in diameter. FIG. 6B shows images of the output channel containing droplets generated under high flow rate, where droplets increase from 86 μm to 115 μm in diameter.

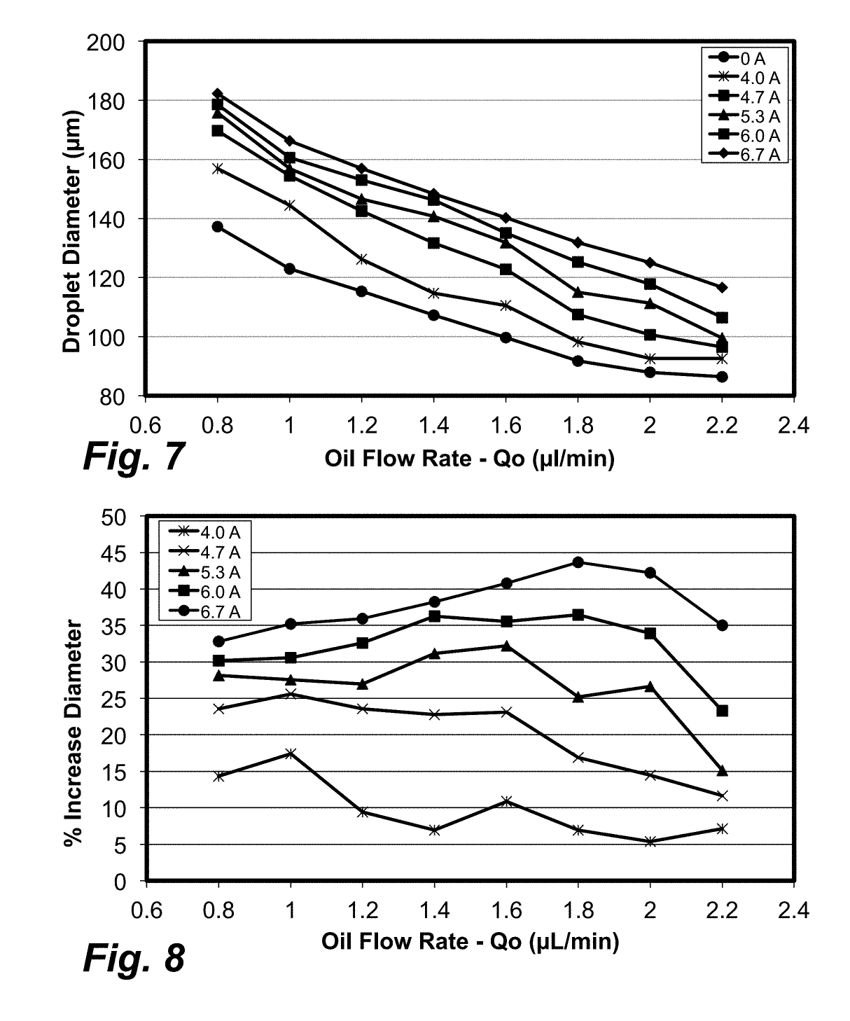

EPM droplet size control was demonstrated for multiple flow rate settings as shown in FIG. 7. As shown in the control curve for the EPM OFF (0 A), droplet sizes can be tuned from approximately 140 to 85 μm using flow rate adjustment, a slow and transient process. Using the maximum actuation current (6.7 A), droplet sizes can be tuned from 185 to 115 μm, in instant step response, as seen in FIGS. 6A-B. There are no transient droplet sizes generated between the OFF and ON setting.

Shear thinning was recorded at higher operating flow rates, as shown in FIG. 8. Droplet size increase diminishes at higher flow rates since particle chain formation is suppressed. Operating at higher actuation currents seems to overcome shear thinning to some extent at lower flow rates, as seen by the droplet size increase for actuation currents above 5.3 A, but eventually dominates at higher flow rates.

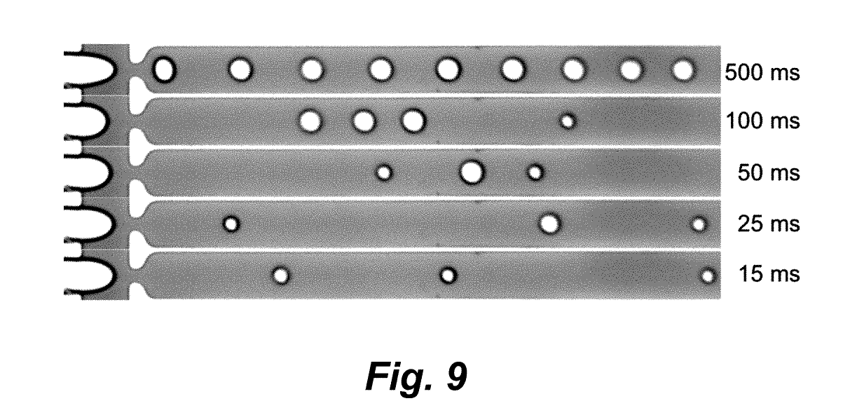

Droplet size tuning with continuous uniform size was demonstrated and it can enable many applications, but on-demand droplet size tuning is also appealing for many reasons. We have demonstrated that by controlling the ON time of the EPM, few large droplets can be generated on-demand, as shown in FIG. 9. Decreasing the ON time even further can lead to single large droplet generation in between normal smaller droplets. This fine level of control can be useful for sorting, sample preparation or other applications where a larger droplet can be used as a marker. Since EPM ON/OFF switching only requires approximately 100 μs, fast on-demand actuation rates can be achieved.

In summary, we have demonstrated that droplet size can be controlled in a flow-focusing geometry by coupling EPM and oil-based ferrofluids. Using EPM actuation, immediate droplet size change was demonstrated without any noticeable size tapering. Even though shear thinning limits the droplet size change at higher flow rates, it was demonstrated that stronger magnetic fields can mitigate this effect. We also demonstrated that EPM switching can be used for on-demand droplet size tuning.

1. A method for active microfluidic droplet generation, the method comprising:
positioning a miniature electropermanent magnet (EPM) such that a magnetic field of the EPM overlaps with microfluidic channels connected to a droplet generation junction upstream from the droplet generation junction;
controlling the magnetic field of the EPM to modulate a continuous phase ferrofluid flow rate in the microfluidic channels while a dispersed phase flows through a dispersed phase channel connected to the droplet generation junction;
whereby dispersed phase droplets are generated with volumes actively controlled on-demand and under continuous flow.

2. The method of claim 1
wherein positioning the EMP comprises
aligning the EMP such that the magnetic field is substantially orthogonal to the microfluidic channels containing the ferrofluid.

3. The method of claim 1
wherein controlling the magnetic field of the EPM to modulate the continuous phase ferrofluid flow rate comprises
controlling the magnetic field to induce a change in viscosity of the ferrofluid through the magnetoviscous effect.

4. The method of claim 1
wherein controlling the magnetic field of the EPM to modulate the continuous phase ferrofluid flow rate comprises
generating current pulses through a coil of the EPM to activate and deactivate the magnetic field of the EPM.

5. The method of claim 1
wherein controlling the magnetic field of the EPM to modulate the continuous phase ferrofluid flow rate comprises
controlling a magnitude of current pulses in coils of the EPM to control a magnitude of the magnetic field.

6. The method of claim 1
wherein controlling the magnetic field of the EPM to modulate the continuous phase ferrofluid flow rate comprises
controlling a magnitude of current pulses in coils of the EPM to produce a maximum magnetic field strength of at least 200 mT at a pole of the EPM.

7. The method of claim 1
wherein controlling the magnetic field of the EPM to modulate the continuous phase ferrofluid flow rate comprises
generating current pulses through a coil of the EPM, where widths of the current pulses are less than 100 microseconds.

8. The method of claim 1
wherein controlling the magnetic field of the EPM to modulate the continuous phase ferrofluid flow rate comprises
maintaining the EPM activated, whereby the volume of the generated dispersed phase droplets is constant.

9. An active microfluidic droplet generation device comprising:
a droplet generation junction comprising i) at least one continuous phase channel adapted for carrying a flow of ferrofluid, and ii) a dispersed phase channel adapted for carrying a dispersed phase flow;
a miniature electropermanent magnet (EPM) positioned upstream from the droplet generation junction and adapted to generate a magnetic field to modulate a flow rate of a ferrofluid in the continuous phase channel.

10. The device of claim 9 wherein the EPM is aligned such that the magnetic field is substantially orthogonal to the continuous phase channel.

11. The device of claim 9 wherein the EPM is positioned within 200 microns of the continuous phase channel.

12. The device of claim 9 wherein the droplet generation junction is a T-junction having just one continuous phase channel.

13. The device of claim 9 wherein the droplet generation junction is a flow-focusing junction having two continuous phase channels.

14. The device of claim 9 wherein the ferrofluid is composed of superparamagnetic nanoparticles suspended in oil or water-based carrier liquid.

15. The device of claim 9 wherein the dispersed phase flow is an aqueous phase flow.

16. The device of claim 9 wherein the dispersed phase flow is a buffer or cell growth media.

17. The device of claim 9 wherein the continuous phase channel and the dispersed phase channel have side and top walls formed of polydimethylsiloxane (PDMS) and bottom walls formed of glass.
